(19) United States
(12) Patent Application Publication
(10) Pub. No.: US 2003/0085105 A1
(43) Pub. Date: May 8, 2003

(54) FEED BELT

(75) Inventors: TSUTOMU SAWA, FUJISAWA-SHI (JP); HIROYUKI TAKENOSHITA, SAGAMIHARA-SHI (JP); HIROHIDE KOMATSU, YOKOHAMA-SHI (JP)

Correspondence Address: SUGHRUE, MION, ZINN,, MACPEAK & SEAS, PLLC, 2100 PENNSYLVANIA AVENUE , N.W., WASHINGTON,, DC, 200373202

(73) Assignee: SUGHRUE MION PLLC

(21) Appl. No.: 09/170,225

(22) Filed: Oct. 13, 1998

(30) Foreign Application Priority Data
Oct. 15, 1997 (JP) 9-282359

(51) Int. Cl. B65G 15/34

(52) U.S. Cl. 198/847

(57) ABSTRACT

A feed belt containing high hardness particles in an elastic material, the high hardness particles capable of being projected from a feed surface by elasticity of the elastic material when a member to be fed is fed, and the projecting amount being varied according to the shape or hardness of the member to be fed. 10 to 70 weight % of high hardness particles having a particle diameter of 3 to 300 μm are contained in an elastic material having a hardness corresponding to rubber hardness 15 to 90.

### BACKGROUND OF THE INVENTION

1. Field of the Invention

The present invention relates to a feed belt for feeding members to be fed such as paper, tickets, bank note, cards, coins and the like in coping machines, printers, facsimiles, scanners, classifiers, printing machines, ticket dispensers, automatic ticket barriers, automatic transaction machines (ATM), coin processors, card type telephones, card readers, money exchangers, note issuing machines and the like.

2. Description of the Prior Art

As elastic materials for forming a feed belt, various kinds of rubber materials (natural rubber and synthetic rubber) have been heretofore used.

The rubber materials used for the feed belt are required to fulfil the characters as listed below:

(1) The rubber material has a high coefficient of friction so as to impart a sufficient feed force to members to be fed.

(2) The coefficient of friction is not considerably lowered due to the change in temperature and humidity (particularly, the change at low temperature and low humidity), the change after passage of year, and the contaminations caused by chemicals, ink, dust or the like.

(3) Hardwearing properties are high.

(4) The rubber hardness can be adjusted in a wide range according to uses.

The performance of rubber materials used for existing feed belts with respect to the requirements of the above-described four characteristics is as follows:

With respect to the characteristics mentioned in (1) above, since the coefficient of friction of rubber is in inverse proportion to the rubber hardness, it is necessary to lower the rubber hardness in order to obtain a high coefficient of friction. However, when the rubber hardness is lowered, the performance relating to the characteristics noted in (2) and (3) mentioned above lowers, which is inconsistent.

With respect to the characteristic mentioned in (2) above, there is a weak point in terms of properties of the rubber itself. At the low temperature the coefficient of friction is lowered due to hardening of rubber, giving rise to inferiority in accuracy of feeding and a trouble in feeding due to skew.

Further, since rubber is a high polymer, the characteristics thereof are unavoidably deteriorated as time passes. Thus, the mechanism has to be adjusted or the material has to be exchanged periodically according to uses.

Furthermore, since rubber is an organic material, there are many rubbers, which are low in chemical resistance. When oils and fats contained in the ink component are adhered thereto, the surface layer of the feed belt is oxidized and hardened to accelerate the lowering of tension, the lowering of coefficient of friction, and the deterioration of characteristics due to denature.

With respect to the characteristic mentioned in (3) above, since the rubber hardness and the hardwearing characteristic are in a proportional relationship, the lowering of rubber hardness immediately results in the lowering of hardwearing characteristic. Therefore, the surface layer of the feed belt is shaved by a stock (material contained in pulp or the like) of paper and carbon particles (graphite, ink and the like) adhered to paper or the like so that the feed belt gradually becomes thin. Replacement of feed belt with new one is necessary in case of high using frequency or in case where high reliability is required.

With respect to the characteristic mentioned in (4) above, when rubber material is molded, adjustment is possible by adding an additive thereto, but other characteristics are changed simultaneously. It is therefore very difficult to balance the both.

As described above, there exists no rubber material satisfying all the characteristics as required above. Further, since the respective characteristics affect on each other, conventionally, a designer selects a rubber material, which fulfils the most important characteristic required, and for other characteristics, the adjustment, cleaning and exchange of the feed belt are repeated for use thereof taking a compromise.

Particularly, in the case where a feed belt is exchanged, it is necessary to remove a number of mechanical parts constituting an apparatus, thus posing a great problem in that considerable labor and time are required for the exchanging operation.

### SUtMMARY OF THE INVENTION

The present invention has been accomplished in order to overcome various problems with respect to the conventional feed belt. An object of the present invention is to provide a feed belt which is strong in the change of environment such as temperature and humidity, has a sufficient hardwearing characteristic, at the same time does not damage a member to be fed, and is holding a high coefficient of friction for a long period,

For achieving the aforementioned object, the present invention provides a feed belt wherein high hardness particles are contained in an elastic material, said high hardness particles capable of being projected from a feeding surface by elasticity of said elastic material when a member to be fed is fed, the projecting amount being varied according to the shape or hardness of said member to be fed.

### BRIEF DESCRIPTION OF THE DRAWINGS

FIG. 1 is a schematic sectional view of a recycle type bank note depositing and dispensing apparatus.

FIG. 2 is an explanatory view showing the basic constitution in the case of linearly feeding by means of a feed belt.

FIGS. 3 (A) to 3 (C) are respectively sectional views, in which the feed belt of the present invention containing ceramic particles in a rubber material is applied to three forms of a flat belt, FIG. 3 (A) showing the form in which a filament is not disposed, FIG. 3 (B) showing the form in which a filament is disposed in a central portion of the belt, and FIG. 3 (C) showing the form in which a filament is disposed on the driving surface side.

FIG. 4 is an explanatory view showing a state in which the ceramic particles somewhat project from the surface of the feeding surface side of the flat belt, the projecting amount being varied.

FIGS. 5 (A) to 5 (C) are respectively sectional views, in which the feed belt of the present invention constituted by a base material layer formed of rubber material and a high hardness particle containing layer containing ceramic particle in the rubber material is applied to three forms of a flat belt, FIG. 5 (A) showing the form in which a filament is not disposed but a high hardness particle containing layer is formed on the feeding surface side, FIG. 5 (B) showing the form in which a filament is disposed in a central portion of the belt and a high hardness particle containing layer is formed on the feeding surface side, FIG. 5 (C) showing the form in which a filament is disposed on the driving surface side and a high hardness particle containing layer is formed on the feeding surface side.

FIG. 6 is a sectional view of main parts of the recycle type bank note depositing and dispensing apparatus shown in FIG. 1.

FIG. 7 is an explanatory view showing the measuring method of a feeding force.

FIG. 8 is an explanatory view showing the method for observing magnetic information recorded on a credit card as an analog voltage waveform.

### DESCRIPTION OF THE PREFERRED EMBODIMENTS

A feed belt according to a first constitution of the present invention is a feed belt containing high hardness particles in an elastic material, said high hardness particles capable of being projected from a feeding surface by elasticity of said elastic material when a member to be fed is fed and the projecting amount thereof being varied according to the shape or hardness of said member to be fed.

Preferably, in the feed belt, 10 to 70 weight % of high hardness particles having 3 to 300 μm of particle diameter are contained in an elastic material having a hardness corresponding to rubber hardness 15 to 90 (shore A scale).

The elastic materials that can be used include rubber materials such as urethane rubber (UR), styrene butadiene rubber (SBR), chloroprene rubber (CR), nitrile rubber (NBR), ethylene propylene rubber (EPDM), silicone rubber (Si) and the like.

Not only rubber material but also plastics or the like can be used as long as they have a suitable elasticity for the feed belt.

The high hardness particles that can be used include ceramic particles such as silicon carbide, alumina, zirconia, codellite, siliconenitride, silicone carbide, and the like.

Not only ceramic particles but also particles such as metallic particles, non-metal particles, ultrahigh alloy particles, or a composite material of these and ceramic can be used if they have ultra-hardness. More specifically, they are carbon tool steel, high speed tool steel, alloy tool steel, titanium carbide (TiC), tungsten carbide (WC), tantalum carbide (TaC), artificial diamond, artificial sapphire, artificial ruby, cermet, and the like.

As the feed belt, elastic materials having a hardness corresponding to rubber hardness 50 to 90 are preferably used in consideration of various characteristics such as coefficient of friction, hardwearing characteristic, flexing characteristics, expansion coefficient and the like.

However, if the high hardness particles are contained, the hardness of elastic material tends to increase. Therefore, in the present invention, the hardness is set to be low in anticipation thereof.

The particle diameter of the high hardness particles is set to 3 to 300 μm because if less than 3 μm, the bite action into the member to be fed is not enough whereas if exceeding 300 μm, the member to be fed tends to be damaged.

The content is set to 10 to 70 weight % because if less than 10 weight %, the number of particles in contact with the member to be fed is small failing to obtain sufficient hardwearing characteristic and bite, whereas if exceeding 70 weight %, the number of particles in contact with the member to be fed is so many that the feed belt lacks flexibility, failing to obtain a sufficient coefficient of friction.

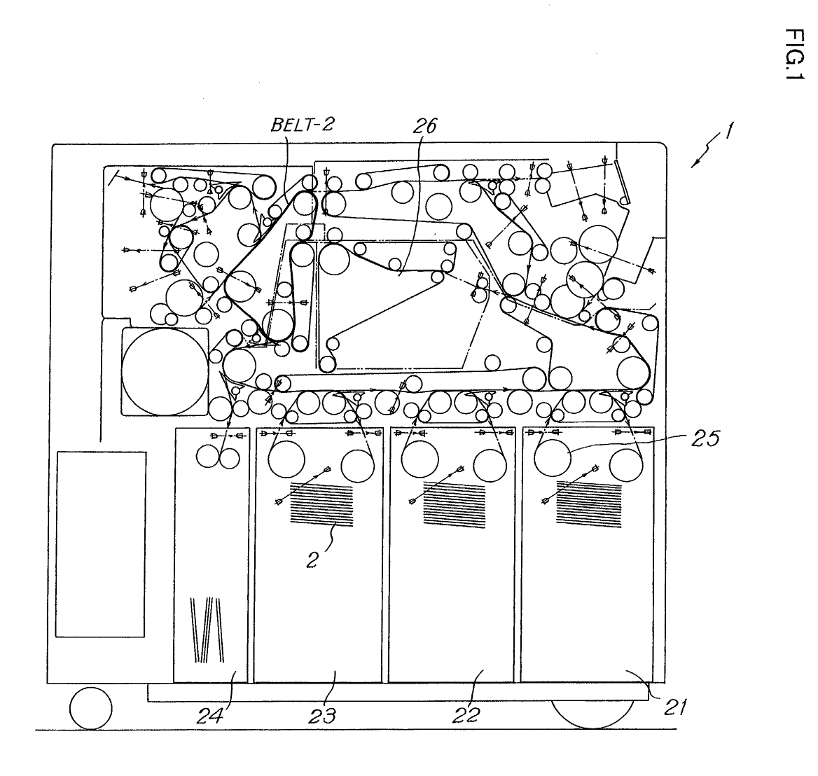

In the preferred embodiment of the present invention, a description has been made of the feed belt used for the bank note depositing and dispensing apparatus for feeding bank note shown in FIG. 1, and the particle diameter of the high hardness particles and the content as described above are employed.

However, the particle diameter and content of the high hardness particles departing from the aforementioned range may be employed according to uses for the feed belt such as the case where only the members to be fed which are hardly subject to damage such as coins or bank note or only the members to be fed which tends to subject to damage such as magnetic cards or the like are fed.

In the feed belt according to the first constitution of the present invention, for members to be fed formed of soft materials such as bank note, paper or the like, the extreme end of high hardness particles is adequately bitten into the surface thereof to promote the feeding force derived from the elastic material of base material whereby imparting the sufficient feeding force to the member to be fed.

Therefore, the sum of the feeding force comprises the addition of the feeding force derived from the biting of the high hardness particles and the feeding force derived from the elastic material of the normal feeding belt.

On the other hand, for the member to be fed formed of somewhat hard material such as a magnetic card, a film or a coin, the high hardness particles are not bitten into the member to be fed to add a force exceeding a predetermined level to the high hardness particles, as a result of which the elastic material of base material holding the high hardness particles is elastically deformed so that the high hardness particles are sunk into from the feeding surface of the feeding belt. Thereby, the contact pressure is suppressed not to be excessive, and the member to be fed is not damaged.

At this time, the high hardness particles placed in contact with the member to be fed under the moderate contact pressure are not bitten but the moderate feeding force is produced by friction, and at the same time, the sunk high hardness particles cause the surface of the elastic material to form with fine concave-convexes, thus providing the effect for enhancing the feeding force.

For the member to be fed whose surface has concave-convex portions such as soft paper, since the feeding surface of the feed belt has fine concave-convex portions from the extreme end portion of the high hardness particles projected from the feeding surface of the feed belt, both the concave-convex portions firmly grasp the mating portions to more positively feed them.

Further, since the high hardness particles are present in the elastic material, the surface of the elastic material between the high hardness particles is protected by the high hardness particles to prevent wear caused by the member to be fed.

Furthermore, since the elastic deformation of the elastic material minimizes the biting of the high hardness particles into the member to be fed, soft materials such as bank note as well as somewhat hard materials such as magnetic cards can be fed positively without damaging the member to be fed.

The feed belt according to a second constitution of the present invention comprises a feed belt constituted by a base material layer formed of elastic material and a high hardness particle containing layer containing high hardness particles in elastic material, in which said high hardness particles can be projected from the feeding surface by elasticity of the elastic material when a member to be fed is fed, and the projecting amount thereof is varied according to the shape and hardness of the member to be fed.

The feed belt is preferably constituted by a base material layer formed of an elastic material having a hardness corresponding to rubber hardness 15 to 90, and a high hardness particle containing layer in which 10 to 70 weight % of high hardness particles having 3 to 300 μm of particle diameter are contained in an elastic material having a hardness corresponding to rubber hardness 15 to 90.

The elastic materials for the base material layer that can be used include rubber materials such as urethane rubber (UR), styrene butadiene rubber (SBR), chloroprene rubber (CR), nitrile rubber (NBR), ethylene propylene rubber (EPDM), silicone rubber (Si) and the like, as described above.

Not only rubber material but also plastics or the like can be used as long as they have a suitable elasticity for the feed belt.

The hardness of elastic material for the base material layer is set to the hardness corresponding to rubber hardness 15 to 90 in consideration of kinds of members to be fed, and various properties required for the feed belts (such as dimensions of configuration, expansion coefficient, load, feed speed, flexing rate, coefficient of friction, temperature and humidity, etc.).

The hardness of elastic materials is set to rubber hardness 15 to 90 because if the high hardness particles are contained, the hardness of elastic material tends to increase, as described above. Therefore, the hardness is set to be low in anticipation thereof.

The feed belt according to the second constitution can provide the function and effect similar to those of the feed belt according to the first constitution by the provision of the high hardness particle containing layer, and in addition, various properties such as the flexing property, expansion coefficient, etc. required for the feed belt can be held similarly to prior art by the provision of the base material layer.

That is, if the hardness of elastic material for the base material layer is made higher than that of elastic material for the high hardness particle containing layer, the high feed force and hardwearing characteristic can be secured by the high hardness particles and at the same time, the tension can be sufficiently loaded by the base material layer, thus enhancing the durability, sufficiently providing the crown effect, and the feed belt not being easily disengaged from the pulleys.

It is necessary to apply tension to the feed belt in order to prevent disengagement and idling of the feed belt during feeding, and looseness of the feed belt due to the weight of members to be fed. However, in the feed belt merely comprising the high hardness particle containing layer, hardness of elastic material is low and elasticity is rich, and a great elongation tends to occur.

When the driving force is applied, other than the static state, the tensile force is further generated on the elongated side of the feed belt, and the feed belt is extended. This elongation is absorbed on the contraction side of the feed belt. However, when the feed belt is low in hardness and low in elastic coefficient, the elongation is so large that the contraction side is loosened, and finally the feed belt may possibly be disengaged from the pulleys. From a viewpoint of this, it is not advisable to soften the entire feed belt. However, the width and thickness thereof are set suitably to enable the use.

In the feed belt merely comprising the high hardness particle containing layer, the hardness of the surface of the feed belt increases, and as a result, the durability also somewhat lowers. However, if an elastic material having a higher hardness than that of the high hardness particle containing layer is used for the basic material layer, the tension is sufficiently born by the base material layer so that the high hardness particle containing layer is not hardened, and the durability can be also enhanced.

Further, in the feed belt formed with the base material layer, the pulleys or the like are not damaged, and the coefficient of friction with respect to the pulleys or the like can be maintained similarly to prior art.

In the recycle type bank note depositing and dispensing apparatus 1 as shown in FIG. 1 according to one embodiment of the feed belt of the present invention, a flat belt for feeding a member to be fed 2 such as paper, bank note, cards or the like will be explained hereinafter.

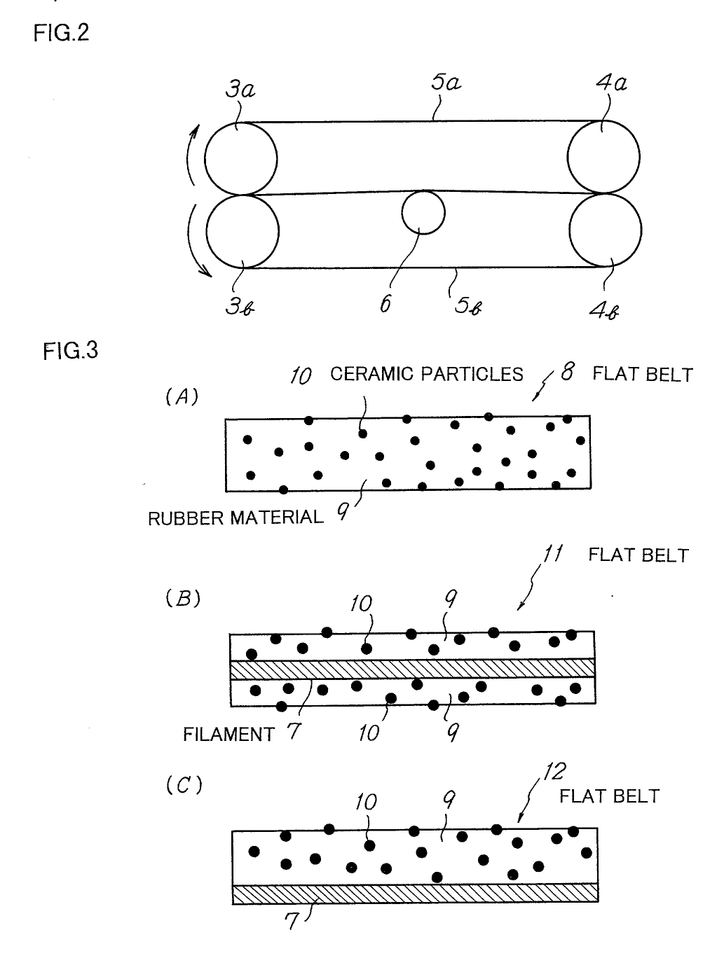

The basic constitution, in the case where the member to be fed 2 such as paper, bank note, cards or the like is linearly fed by a flat belt, is as shown in FIG. 2.

A flat belt 5a extended between pulleys 3a and 4a and a flat belt 5b extended between pulleys 3b and 4b are placed in contact together in their feeding surfaces, and a tension pulley 6 is pressed against the flat belt 5b so that tension is applied thereto.

The member to be fed 2 such as paper, bank note, cards or the like is held between the flat belts 5a and 5b, and fed by the frictional force generated between the flat belts 5a and 5b.

There are normally three forms of the flat belt according to the presence or arranging position of a filament (fabric, filament wire) 7. The filament 7 is normally disposed in the central portion of the belt or on the driving surface for which the pulley comes in contact, in consideration of the function of the belt.

In these three forms, when the feed belt according to the first constitution is applied, the arrangement is as shown in FIGS. 3 (A) to 3 (C).

FIG. 3 (A) shows a flat belt 8 in which the filament 7 is not disposed. 10 to 70 weight % of ceramic particles 10 having 3 to 300 μm of particle diameter are uniformly contained in a rubber material 9 having 15 to 90 of rubber hardness.

The flat belt 8 is produced in such a manner that 10 to 70 weight % of ceramic particles 10 having 3 to 300 μm of particle diameter are mixed into the rubber material 9 having 15 to 90 of rubber hardness and well blended, and the ceramic particles 10 are uniformly dispersed and molded to have a predetermined thickness, after which polishing is applied to obtain a finished product.

In polishing process, in the surface of the belt subjected to cut pressure of a grinding-stone, the ceramic particles 10 which are extremely harder than the rubber material 9 are first sunk into the rubber material 9. Therefore, first, the rubber material 9 is shaved, and when the cut pressure is further applied, the ceramic particles 10 are then shaved. Therefore, the surface of the flat belt 8 after polishing process assumes the state in which the ceramic particles 10 are projected from the surface of the flat rubber material 9.

For better bonding state between the ceramic particles 10 and the rubber material 9, after a bonding material has been adhered to the ceramic particles 10, the ceramic particles 10 may be mixed into the rubber material 9.

As the bonding material, a silane bonding material can be used, but other suitable bonding materials can be used if adhesive properties relative to the rubber material 9 are good.

A number of ceramic particles 10 contained in the rubber material 9 are projected by a fine amount from the surface of the flat belt 8. For a member to be fed formed of soft materials such as paper, bank note or the like, the extreme ends of the ceramic particles 10 are suitably bitten into the surface thereof, and for a member to be fed formed of hard materials such as a card, a coin or the like, when pressure in excess of a predetermined level is applied to the flat belt 8, the rubber material 9 is elastically deformed, whereby a suitable feeding force is to be applied.

The high hardness ceramic particles 10 prevents the wear of the flat belt 8 caused by the member to be fed, and the elastic deformation of the rubber material 9 minimizes the biting of the ceramic particles 10 into the member to be fed, and therefor, the member to be fed is positively fed without being damaged.

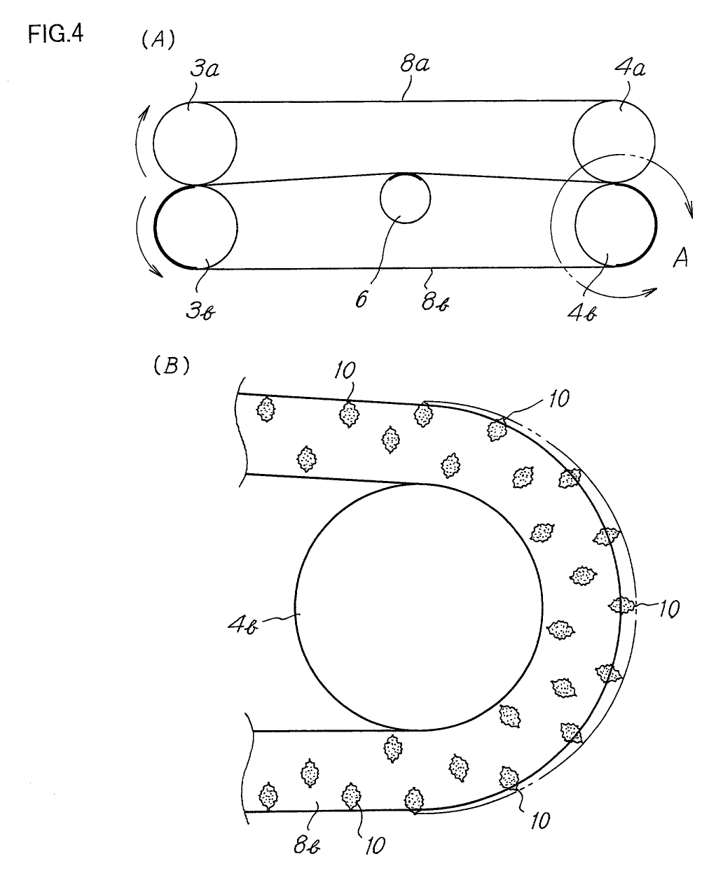

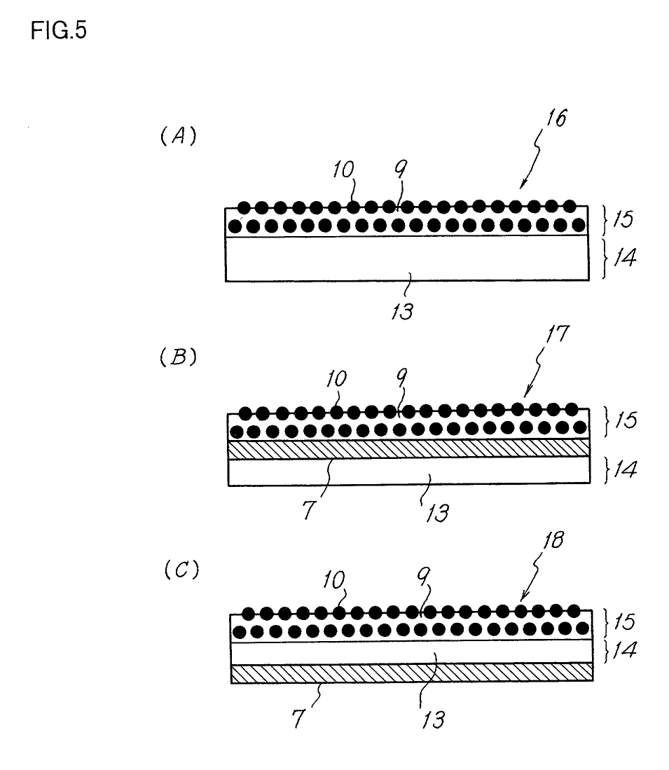

As shown in FIGS. 4(A) and 4(B), when the flat belt 8 is extended by the pulleys 3, 4 and 6, the flat belt 8 is stretched along the outer periphery of the pulley 4b, at which time, the flat belt 8 is extended excessively in its outer peripheral side than its inner peripheral side due to the difference of radius from the center of the shaft of the pulley 4b. As a result, since the outermost peripheral portion of the flat belt 8 is further pulled, the ceramic particles 10 are somewhat projected from the surface on the feeding surface of the flat belt 8 whereby the member to be fed can be powerfully moved in and out.

In addition, the pulleys 3, 4 and 6 for the flat belt 8 are normally in the shape of a barrel whose central portion is swelled, that is, outside diameter of the central portion of which is largest (crown effect), in order to prevent disengagement of the flat belt 8, by which the central portion of the flat belt 8 is particularly swelled, and the projecting amount of the ceramic particles is maximum. Accordingly, the member to be fed can be firmly caught by the ceramic particles 10 at the inlet at which the frictional force is most required.

In the case where the flat belt 8 merely comprising the high hardness particle containing layer is used, as shown in FIG. 4(B), since the rubber hardness of the flat belt 8 is uniform, the difference in elongation between the outer peripheral surface and the inner peripheral surface is generally somewhat smaller than the flat belt of dual construction so that the projecting amount of the ceramic particles 10 is small. However, when the base material layer having a higher rubber hardness than the high hardness particle containing layer is arranged on the driving surface side, the elongation of the inner peripheral portion of the flat belt is further smaller than that of the outer peripheral portion, and the ceramic particles 10 in the outer peripheral portion greatly project.

FIG. 3(B) shows a flat belt 11 in which the filament 7 is disposed in the central portion of the belt. FIG. 3(C) shows a flat belt 12 in which the filament 7 is disposed on the driving surface side, but other constitutions are similar to the flat belt 8 shown in FIG. 3(A).

With respect to three forms according to the presence and arrangement position of the filament (fabric, filament wire) 7, when the feed belt of the second constitution is applied, the arrangement is as shown in FIGS. 5(A) to 5(C).

FIG. 5(A) shows a flat belt 16 in which the filament 7 is not disposed and in which a base material layer 14 formed of rubber material 13 having 15 to 90 of rubber hardness is formed on the driving surface side, and a high hardness particle containing layer 15, in which 10 to 70 weight % of ceramic particles 10 having 3 to 300 μm of particle diameter are uniformly contained in rubber material 9 having 15 to 90 of rubber hardness, is formed on the feeding surface side.

The flat belt 16 is produced in such a manner that 10 to 70 weight % of ceramic particles 10 having 3 to 300 μm of particle diameter are uniformly contained in rubber material 9 having 15 to 90 of rubber hardness and well blended to uniformly disperse the ceramic particles 10 to mold it to have a predetermined thickness, after which the polished high hardness particle containing layer 15 is molded to have a predetermined thickness by the rubber material 13 having 15 to 90 of rubber hardness, which is thereafter deposited on or adhered to the surface of the polished base material layer 14.

Preferably, the base material layer 14 has a thickness of 0.5 to 1.5 mm, and the high hardness particle containing layer 15 has a thickness of 0.2 to 1.0 mm.

The base material layer 14 is made to have a thickness of 0.5 to 1.5 mm whereas the high hardness particle containing layer 15 is made to have a thickness of 0.2 to 1.0 mm because if less than 0.2 mm, the biting action into the member to be fed and the elastic deformation action as described above cannot be obtained simultaneously, and when exceeding 1.0 mm, various properties such as flexing characteristic, expansion and the like are hard to be held similarly to prior art.

The flat belt 16 can provide the function and effect similar to the flat belts 8, 11 and 12 by the provision of the high hardness particle containing layer 15, and in addition, various properties such as flexing characteristic, expansion and the like required by the feed belt can be held by the provision of the base material layer 14 similarly to prior art.

That is, if the hardness of the rubber material 13 of the base material layer 14 is made higher than that of the elastic material 9 of the high hardness particle containing layer 15, the high feed force and hardwearing characteristic can be secured by the high hardness particle containing layer 15, and at the same time, tension can be well loaded by the base material layer 14 so that the durability is enhanced, the crown effect is prevented from lowering, and the flat belt 16 is not easily disengaged from the pulleys.

FIG. 5(B) shows a flat belt 17 in which the filament 7 is disposed in the central portion of the belt, the base material layer 14 is formed on the driving surface side, and the high hardness particle containing layer 15 is formed on the feeding surface side. FIG. 5(C) shows a flat belt 18 in which the filament 7 is disposed on the driving surface side, the high hardness particle containing layer 15 is formed on the feeding surface side, and the base material layer 14 is formed between the filament 7 and the high hardness particle containing layer 15, other constitutions of which are similar to the flat belt 16 shown in FIG. 5 (A).

The flat belts 16 and 17 formed with the base material layer 14 on the feeding surface side are more preferable because the pulleys or the like are not damaged, and the coefficient of friction with respect to the pulleys or the like can be held similar to prior art.

Further, in the flat belt 18 in which the filament 7 is disposed on the driving surface side, tension can be born to some extent by the filament 7, and the durability can be also secured. Therefore, the hardness of the rubber material 13 of the base material layer 14 may be lowered than that of the rubber material 9 of the high hardness particle containing layer 15.

According to such a flat belt 18 as described, the rubber material 13 of the base material layer 14 tends to be elastically deformed more easily with respect to the member to be fed formed of a slightly hard material, and the effect of suppressing contact pressure increases not to damage the member to be fed.

Further, the fine concave-convex portions on the feeding surface of the flat belt 18 and the concave-convex portions on the surface of the member to be fed mutually and firmly catch the member to be fed having the concave-convex portions on the surface thereof to enable more positive feeding.

While in the foregoing, a description has been made of the flat belt, it is to be noted that the present invention can be also applied to feed belts having various sectional shapes such as a flat belt, a round belt, a trapezoidal belt, etc.

The feed belt according to the present invention was manufactured by way of trial, which was compared with the conventional feed belt in characteristics. This will be explained below.

### EXAMPLE 1

30 weight % of silicone carbide particles having 57 μm of average particle diameter were mixed into chloroprene rubber (CR) having rubber hardness 60, well blended and uniformly dispersed and molded to have a predetermined thickness, and thereafter, the material was subjected to polishing to prepare a feed belt A having a thickness of 1.12 mm according to the present invention.

Note the rubber hardness of rubber material was 68 since the silicone carbide particles are contained.

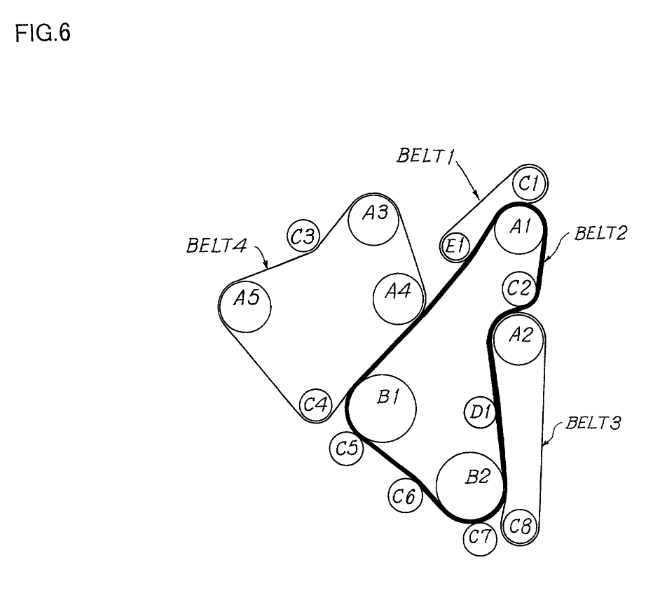

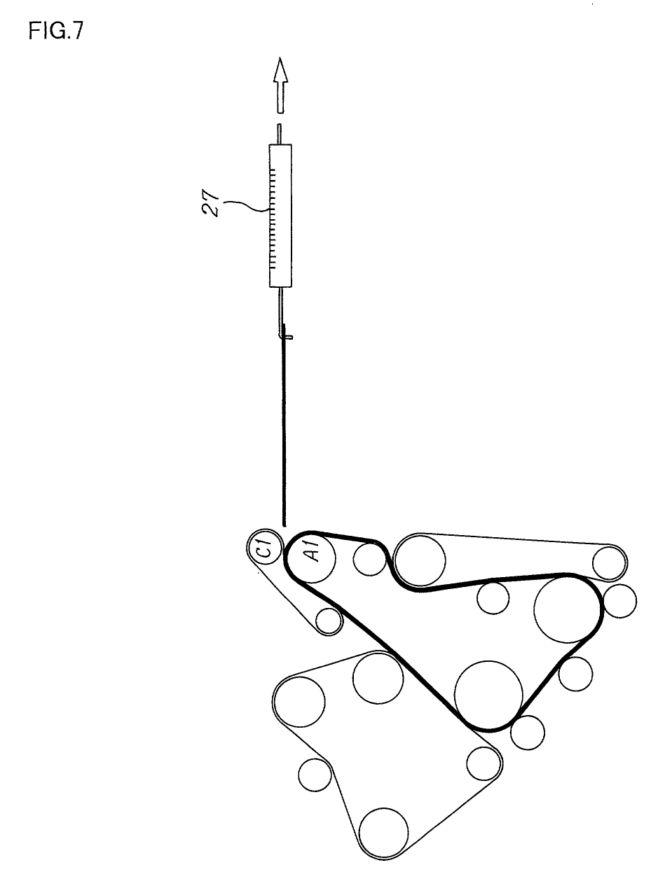

The feed belt A according to the present invention was extended over the pulleys as shown in FIG. 6, and the life acceleration test was conducted under the following conditions. The apparatus used for test is the recycle type bank note depositing and dispensing apparatus shown in a schematic section of FIG. 1.

*TESTING CONDITIONS

| | |
|---|---|
| Test environment | Room temperature (20° C.) |
| Test apparatus | IBM 4744 Recycle type bank note depositing and |
| | dispensing apparatus |
| Member to be fed | Bank note for testing |
| Feed speed | 1.6 m/sec |
| Evaluation belt | BELT-2 (see FIG. 6) |
| Belt type | Flat belt |
| Belt dimension | See Table 2 |
| Belt elongation rate | 8% |
| Pulley diameter | See Table 1 |
| Pulley position | See Table 1 |
| Feed method | 2000 sheets of bank note in a cartridge 21 are stored |
| | one by one in a cartridge 22 via a determiner 26 by |
| | a pickup roller 25. The bank note stored in the |
| | cartridge 22 is similarly stored in the cartridge 21 |
| | via the determiner 26. Sheets of bank note |
| | unsuitable for recycle which are bent or torn are |
| | collected in a cartridge 24, and shortage of bank |
| | note is replenished by a cartridge 23. The above- |
| | described operation is repeated. |
| Number of sheets of | 3,000,000 sheets |
| bank note fed | |

TABLE 1

| PULLEY | | PULLEY POSITION | | | |
|---|---|---|---|---|---|
| DIAMETER | PULLEY NO. | X COORDINATE | | Y COORDINATE | |
| ∅ 28 mm | A1 | 0.0 | mm | 0.0 | mm |
| | A2 | −1.8 | mm | −61.0 | mm |
| | A3 | −79.0 | mm | 7.0 | mm |
| | A4 | −67.0 | mm | −37.0 | mm |
| | A5 | −150.0 | mm | −40.0 | mm |
| ∅ 38 mm | B1 | −76.5 | mm | −99.0 | mm |
| | B2 | −30.5 | mm | −144.0 | mm |
| ∅ 19 mm | C1 | 6.0 | mm | 26.0 | mm |
| | C2 | −1.0 | mm | −33.0 | mm |
| | C3 | −118.5 | mm | −1.0 | mm |
| | C4 | −113.3 | mm | −96.3 | mm |
| | C5 | −96.1 | mm | −121.0 | mm |
| | C6 | −65.3 | mm | −148.5 | mm |
| | C7 | −25.3 | mm | −173.0 | mm |
| | C8 | −4.0 | mm | −167.0 | mm |
| ∅ 18 mm | D1 | −23.0 | mm | −102.0 | mm |
| ∅ 15 mm | E1 | −34.7 | mm | −8.9 | mm |

TABLE 2

| BELT NO. | BELT DIMENSION | | |
|---|---|---|---|
| BELT-1 | 1 mm (thickness) | ×10 mm (width) | ×154 mm (length) |
| BELT-2 | 1 mm | ×10 mm | ×420.5 mm |
| BELT-3 | 1 mm | ×10 mm | ×266 mm |
| BELT-4 | 1 mm | ×10 mm | ×330 mm |

*BELT-2 is the belt according to the present invention. Other belts are belts of urethane rubber having hardness 70.

### EXAMPLE 2

30 weight % of silicone carbide particles having 57 μm of average particle diameter were mixed into chloroprene rubber (CR) having rubber hardness 30, well blended, uniformly dispersed and molded to have a predetermined thickness, and thereafter, the material was subjected to polishing to form a high hardness particle containing layer having a thickness of 0.3 mm. Chloroprene rubber (CR) having rubber hardness 70 was molded to have a predetermined thickness and after this, applied with polishing to form a base material layer having a thickness of 0.7 mm. The high hardness particle containing layer was deposited thereon to prepare a feed belt B having a thickness of 1.04 mm according to the present invention.

Note the rubber hardness of rubber material of the high hardness particle containing layer was 37 since the ceramic particles are contained.

The life acceleration test was conducted under the same conditions as EXAMPLE 1 using the feed belt B according to the present invention.

### COMPARATIVE EXAMPLE

Chloroprene rubber (CR) having rubber hardness 70 was molded to have a predetermined thickness and after this, applied with polishing to prepare a conventional feed belt having a thickness of 1.05 mm.

The life acceleration test was conducted under the same conditions as EXAMPLE 1 using the conventional feed belt.

With respect to the results of the life acceleration test, Table 3 shows the comparison between the feed belts A and B of the present invention and the conventional feed belt every various properties.

TABLE 3

| | | CONVENTIONAL | | |
|---|---|---|---|---|
| | PROPERTIES | FEED BELT | FEED BELT-A | FEED BELT-B |
| 1 | Rate of wear | 5.71% | 0.89% | 0.96% |
| | (changing rate of thickness) *1 | | | |
| | Thickness of feed belt | | | |
| | A before test | 1.05 mm | 1.12 mm | 1.04 mm |
| | B after test | 0.99 mm | 1.11 mm | 1.03 mm |
| | (after 3 million times) | | | |
| | Amount of wear | 0.06 mm | 0.01 mm | 0.01 mm |
| 2 | Reduction rate of feed force *2 | 48% | 17% | 13% |
| | Feed force of feed belt | | | |
| | A before test | 310 g | 380 g | 390 g |
| | B after test | 160 g | 315 g | 340 g |
| | (after 3 million times) | | | |
| | Amount of reduction | 150 g | 65 g | 50 g |
| 3 | Changing rate of rubber hardness | 1.04 | 1.01 | 1.01 |
| | A before test | 67 | 67 | |
| | B after test | 68 | 68 | |
| | (after 3 million times) | | | |

*1 Rate of wear (changing rate of thickness) = (1-B/A) × 100
*2 Reduction rate of feed force = (1-B/A) × 100

In Table 3, the feed force is the force when, a member to be fed being put between the feeding surfaces of the feed belt, the member to be fed starts to move when the member to be fed is pulled out, the feed force being in a proportional to the coefficient of friction.

In the present example, as shown in FIG. 7, a member to be fed 2 is put between pulleys A1 and C1, and one end thereof is pulled by a spring scale 27 for measurement.

As shown in Table 3, the feed belts A and B of the present invention have remarkably enhanced characteristics relating to the feeding force, that is, the coefficient of friction and hardwearing characteristic as compared with the conventional feed belt.

In the conventional feed belt, the surface having fine concave-convex portions formed in the polishing process when in manufacture becomes worn and flattened with the use, and therefore, the coefficient of friction gradually lowers.

On the other hand, in the feed belts A and B of the present invention, since the ceramic particles are present, the belt surface is not uniformly shaved but the concave-convex portions on the surface are retained after the use for a long period, and the lowering of the coefficient of friction is suppressed.

Next, an extent or limit of damage given to cards by the feed belt of the present invention was examined.

### EXAMPLE 3

A testing card 28 to which is attached a magnetic stripe tape was used, and the feed belt A was used. The testing card 28 was continuously fed 100 times under the same conditions as the aforementioned life acceleration test.

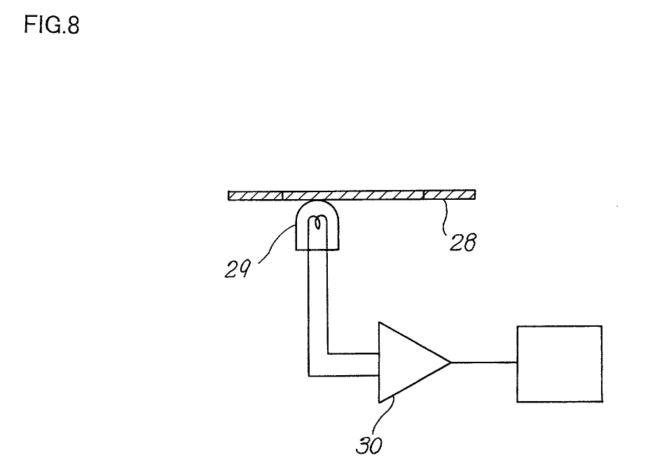

The surface of the magnetic stripe tape on the testing card 28 was rubbed by a magnetic head 29 as shown in FIG. 8, and magnetic information recorded was observed by an analog voltage waveform at the output end of an amplifier circuit 30.

### EXAMPLE 4

Likewise, the surface of the magnetic stripe tape on the testing card after conduction of the life acceleration test, using the feed belt B, was rubbed by the magnetic head 29 as shown in FIG. 8, and magnetic information recorded was observed by an analog voltage waveform at the output end of the amplifier circuit 30.

It has been found that in any of the aforementioned observed waveforms of magnetic information, the maximum voltage and voltage amplitude are constant and regularly over the lengthwise of the testing card, and in the case of being fed by the feed belts A and B of the present invention, the magnetic information is sufficiently retained.

As described above, in the feed belt of the present invention, the coefficient of friction is high, the coefficient of friction is not affected by the change of environments such as temperature and humidity, and the belt has the sufficient hardwearing characteristic. The change after a lapse of time in the coefficient of friction of the surface is also small.

According to the feed belt of the present invention, for a member to be fed formed of soft material, the extreme end portions of the high hardness particles are moderately bitten into the surface thereof, and for a member to be fed formed of somewhat hard material, when pressure in excess of a predetermined level is applied to the feed belt, elastic material is elastically deformed, whereby a moderate feed force can be applied to the member to be fed.

The fine concave-convex portions formed on the feed surface of the feed belt and the concave-convex portions on the surface of the member to be fed mutually and firmly catch the member to be fed having the concave-convex portions on the surface thereof to more positively feed it.

Further, the high hardness particles prevent a considerable wear in a short period of the feed belt caused by the member to be fed, and the elastic deformation of elastic material suppresses the biting of the high hardness particles into the member to be fed to minimum, thereby enables the positive feeding without damaging the member to be fed.

According to the feed belt comprising a base material layer formed of elastic material and a high hardness particle containing layer containing high hardness particles in the elastic material, the above-described function and effect can be provided by the high hardness particle containing layer, and in addition, various properties such as flexing characteristic, expansion coefficient and the like required for the feed belt can be retained similar to prior art by the base material layer.

For those in which the base material layer is formed on the driving surface side, the pulleys or the like are not damaged, and the coefficient of friction, expansion coefficient and flexing characteristic relative to the pulleys or the like can be retained similar to prior art.

1. A feed belt containing high hardness particles in an elastic material, characterized in that said high hardness particles can project from a feed surface by elasticity of said elastic material when a member to be fed is fed, and the projecting amount is varied according to the shape or hardness of said member to be fed.

2. A feed belt in which 10 to 70 weight % of high hardness particles having a particle diameter of 3 to 300 μm are contained in an elastic material having a hardness corresponding to rubber hardness 15 to 90.

3. The feed belt according to claim 2, wherein a filament is disposed in a central portion of the belt.

4. The feed belt according to claim 2, wherein a filament is disposed on the driving surface side.

5. A feed belt comprising a base material layer formed of an elastic material, and a high hardness particle containing layer containing high hardness particles in the elastic material, characterized in that said high hardness particles can project from a feed surface by elasticity of said elastic material when a member to be fed, and the projecting amount is varied according to the shape or hardness of said member to be fed.

6. A feed belt comprising a base material layer formed of an elastic material having a hardness corresponding to rubber hardness 15 to 90, and a high hardness particle containing layer containing 10 to 70 weight % of high hardness particles having a particle diameter of 3 to 300 μm in the elastic material having a hardness corresponding to rubber hardness 15 to 90.

7. The feed belt according to claim 6, wherein a filament is disposed in a central portion of the belt, said base material layer being formed on the driving surface side, said high hardness particle containing layer being formed on the feed surface side.

8. The feed belt according to claim 5, wherein a filament is disposed on the driving surface side.
